(19) United States
(12) Patent Application Publication
(10) Pub. No.: US 2026/0127027 A1
(43) Pub. Date: May 7, 2026

(54) INTEGRATED OBSERVATIONS PREPROCESSING SYSTEM AND METHOD FOR OCEAN DATA ASSIMILATION SYSTEM

(71) Applicant: NATIONAL INSTITUTE OF METEOROLOGICAL SCIENCES, Seogwipo-si (KR)

(72) Inventors: Johan LEE, Seogwipo-si (KR); Sang-Min LEE, Seogwipo-si (KR); Yu-Kyung HYUN, Seogwipo-si (KR)

(21) Appl. No.: 19/376,383

(22) Filed: Oct. 31, 2025

(30) Foreign Application Priority Data
Nov. 6, 2024 (KR) 10-2024-0156454

(51) Int. Cl. G06F 9/48

(52) U.S. Cl. CPC G06F 9/4881

(57) ABSTRACT

Provided herein is an integrated preprocessing system and method for observation data of an ocean data assimilation system, which can maximize efficiency in overall processes of observation data collection, quality control, data processing, and operation management, and enhance the stability and reliability of the preprocessing process. The integrated preprocessing system for observation data of an ocean data assimilation system according to the present disclosure includes: an observation data collection unit configured to collect ocean observation data required for the ocean data assimilation system; a data processing unit configured to perform quality control on the collected observation data and classify and process the collected observation data into a single executable file; and a monitoring unit configured to perform GUI-based job scheduling and monitoring using a Rose/Cylc operating system.

### CROSS-REFERENCE TO RELATED APPLICATION

This application claims priority to Korean Patent Application No. 10-2024-0156454 filed on Nov. 6, 2024, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to an integrated preprocessing system and method for observation data of an ocean data assimilation system. In particular, the present disclosure relates to an integrated preprocessing system and method for observation data of an ocean data assimilation system, which can enhance the stability and reliability of the preprocessing process.

### Description of the Related Art

The Global Ocean Data Assimilation and Prediction System (GODAPS) has been operated since 2018, constructed based on the Forecasting Ocean Assimilation Models (FOAM), which is the operational system of the UK Met Office, in order to provide marine meteorological forecast information to the public, the Air Force, and related organizations (Chang et al., 2021). In order to independently produce and provide the ocean-sea ice initial fields for the improved climate prediction system (GloSea6), the previous Global Ocean Data Assimilation and Prediction System (GODAPS) was upgraded (GODAPS version 2, GODAPS2), and an operational system was established and put into operational service in October 2021. GODAPS was operated until February 2022 and then terminated.

However, the preprocessing process of observation data in the previous Global Ocean Data Assimilation and Prediction System (GODAPS) has the following problems.

1) Since a simple scheduling tool such as crontab was used to manage tasks in the past, the task status had to be checked manually, and it was difficult to respond immediately when an error occurred. This caused task delays and led to a problem of lowering operational efficiency.

Here, crontab refers to a scheduling tool used in UNIX or Linux operating systems to automatically execute periodically repeated tasks (e.g., backup, data processing).

2) In the existing system, the quality of the collected observation data was not finely managed, so there was a risk that low-quality data could be included in the data assimilation process. As a result, the possibility of data contamination increased, and this had a negative effect on prediction accuracy.

3) The existing system used a fixed memory allocation method, and thus, when processing large-volume data, memory usage was inefficient. In particular, for processing high-resolution satellite-observed sea surface temperature data, high-performance resources were required. This increased operating costs and reduced the flexibility of the system.

4) Since various observation data formats had to be managed with individual programs, whenever new data formats were added or changed, program updates and compilation were required, which increased the complexity of maintenance and could cause user confusion.

### Related Patent Document

(Patent Document 1) Korean Registered Patent Publication No. 10-2220748 (Feb. 26, 2021)

(Patent Document 2) Korean Registered Patent Publication No. 10-2492075 (Jan. 26, 2023)

### SUMMARY OF THE DISCLOSURE

The purpose of the present disclosure, which is directed to solving the aforementioned conventional problems, is to provide an integrated preprocessing system and method for observation data of an ocean data assimilation system. The system and method can maximize efficiency in overall processes such as observation data collection, quality control, data processing, and operation management, and enhance the stability and reliability of the preprocessing. In addition, the purpose of the present disclosure is to provide an integrated preprocessing system and method for observation data in ocean data assimilation system, which incorporating centralized GUI-based management adopting the Rose/Cylc workflow management system, resource saving through dynamic memory allocation and enhanced data reliability using QC flags.

In order to achieve the purpose, an aspect of the present disclosure provides an integrated preprocessing system for observation data of an ocean data assimilation system, comprising:
an observation data collection unit configured to collect ocean observation data;
a data processing unit configured to perform quality control on the collected observation data and to classify and process the collected observation data into a single executable file; and
a monitoring unit configured to perform GUI-based job scheduling and monitoring using a Rose/Cylc workflow management system.

In some exemplary embodiments, the integrated preprocessing system may further comprise an boundary data processing and generation unit for producing meteorological boundary data.

In some exemplary embodiments, the data processing unit may comprise:
a quality control unit configured to apply QC flags to the collected observation data, refine the collected observation data, and convert the refined observation data into standardized data; and
a single processing unit configured to classify and process the converted observation data into a predetermined single executable file.

In some exemplary embodiments, the quality control unit may comprise:
a QC module configured to apply QC flags to the collected observation data according to ocean depth; a refinement module configured to refine the collected observation data verified by the applied QC flags; and a conversion module configured to convert the refined observation data into a standardized data format in an explicit manner.

In some exemplary embodiments, the single processing unit may comprise:
a common subroutine module configured to classify and process the converted observation data into an executable file of a common subroutine; and
a memory allocation module configured to process the converted observation data using a dynamic memory allocation method based on a linked list.

In some exemplary embodiments, the monitoring unit may comprise:
a parallel task management module configured to check task statuses in real time through a CYLC graph on a GUI basis using a Rose/Cylc workflow management system; and
a log module configured to check logs of respective tasks on the GUI.

In addition, in order to achieve the purpose, another aspect of the present disclosure provides an integrated preprocessing method for observation data of an ocean data assimilation system, comprising:
(a) an observation data collecting step of collecting ocean observation data;
(b) a data classifying and processing step of performing quality control on the collected observation data, and classifying and processing the collected observation data into a single executable file; and
(c) a monitoring step of performing GUI-based job scheduling and monitoring using a Rose/Cylc workflow management system.

In some exemplary embodiments, the step (b) may comprise:
(b1) a step of applying QC flags to the collected observation data, refining the collected observation data, and converting the refined observation data into standardized data; and
(b2) a data processing step of classifying and processing the converted observation data into a predetermined single executable file.

In some exemplary embodiments, the step (b1) may comprise:
a step of applying QC flags to the collected observation data according to ocean depth;
a step of refining the collected observation data verified by the applied QC flags; and
a step of converting the refined observation data into a standardized data format in an explicit manner.

In some exemplary embodiments, the step (b2) may comprise:
a step of classifying and processing the converted observation data into an executable file of a common subroutine.

In some exemplary embodiments, the step (b2) may comprise:
a step of processing the converted observation data using a dynamic memory allocation method based on a linked list.

In some exemplary embodiments, the step (c) may comprise:
a parallel task management step of checking task statuses in real time through a CYLC graph on a GUI basis using a Rose/Cylc workflow management system; and
a step of checking logs of respective tasks on the GUI.

Furthermore, still another aspect of the present disclosure provides a computer program stored in a medium for executing the integrated preprocessing method for observation data of an ocean data assimilation system as described above on a computer.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, by utilizing the ECCODES library, data of various formats (BUFR, GRIB, etc.) can be explicitly processed, thereby flexibly responding to the latest observation data formats and periodic table updates.

In addition, according to the present disclosure, since multiple types of observation data can be processed into a single executable file, management efficiency is improved, and there is no need to update or compile a separate program whenever a new data format is added. Through this, consistency of the preprocessing process can be maintained, while the data processing speed can be improved.

In addition, according to the present disclosure, by applying quality control (QC) flags to each level of the collected data, low-quality data can be removed in advance, thereby greatly enhancing the reliability of the data.

In addition, according to the present disclosure, through the quality control process, data with outliers or errors is refined, and only the verified data is converted into a standardized data format, thereby preventing data contamination in subsequent steps and improving prediction accuracy in the data assimilation process.

In addition, according to the present disclosure, by introducing a dynamic memory allocation method based on a linked list, memory usage can be optimized, and even in cases of tasks requiring more than 100 GB of memory, processing can be performed with about one-third of the memory usage, thereby improving efficiency in processing large-scale data in the future.

In addition, according to the present disclosure, thanks to the dynamic memory allocation method, resources can be saved and system performance can be improved, contributing to enhancing the stability of the overall system and enabling smooth data processing in various environments.

In addition, according to the present disclosure, the Rose/Cylc workflow management system supports intuitive monitoring of all tasks through a GUI, allows visual checking of the parallel progress status of multiple tasks through a CYLC graph, and enables easy checking of task logs on the GUI, thereby providing high visibility to operators.

In addition, according to the present disclosure, since the status of tasks can be identified in real time, causes can be immediately identified and responded to when errors occur, thereby enhancing the stability of system operation, minimizing task delays, and improving overall operational efficiency.

In addition, according to the present disclosure, the Rose/Cylc workflow management system can monitor multiple tasks in parallel, effectively manage the entire process of the preprocessing procedure, clearly manage dependencies among tasks, and increase processing speed through parallel tasks, thereby maximizing efficiency in large-scale data preprocessing.

In addition, according to the present disclosure, through FCM (Flexible Code Management), source code can be efficiently managed, and by systematizing the compilation process, consistency of tasks can be maintained when updating programs, collaboration and development efficiency can be improved, and confusion that may occur in maintenance work can be reduced.

### BRIEF DESCRIPTION OF THE DRAWINGS

FIG. 1 is a diagram showing a block configuration of an integrated preprocessing system for observation data of an ocean data assimilation system according to an exemplary embodiment of the present disclosure.

FIG. 2 is a diagram showing a detailed flow of an integrated preprocessing method for observation data of an ocean data assimilation system according to an exemplary embodiment of the present disclosure.

FIG. 3 is a diagram showing a screen of a Cylc window in which progress is being performed in real time in an ocean data assimilation system according to an exemplary embodiment of the present disclosure.

FIG. 4 is a diagram showing a GUI screen displaying task statuses and the like in an ocean data assimilation system according to an exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component. In a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited by the used terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently and clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Moreover, one or more “unit” and/or “module” described in this specification can be implemented via a non-transitory memory (not shown) and a processor (not shown). The memory is configured to store data concerning algorithms designed to control the operation of system components according to exemplary embodiments of the present disclosure, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

Furthermore, in the specification of the present disclosure, terms such as “unit,” “device,” “module,” and “apparatus,” if used, refer to a unit capable of processing one or more functions or operations and should be understood to be implementable in hardware, software, or a combination of hardware and software.

As will be understood by those skilled in the art, the realization of all or some of the steps of the above exemplary embodiments may be accomplished through hardware, or may be accomplished by directing the relevant hardware through a computer program. The computer program may include instructions for executing some or all of the steps of the method, the computer program may be stored on a readable storage medium, and the storage medium may be any form of storage medium.

Hereinafter, exemplary embodiments of the present disclosure will be described in detail with reference to related drawings.

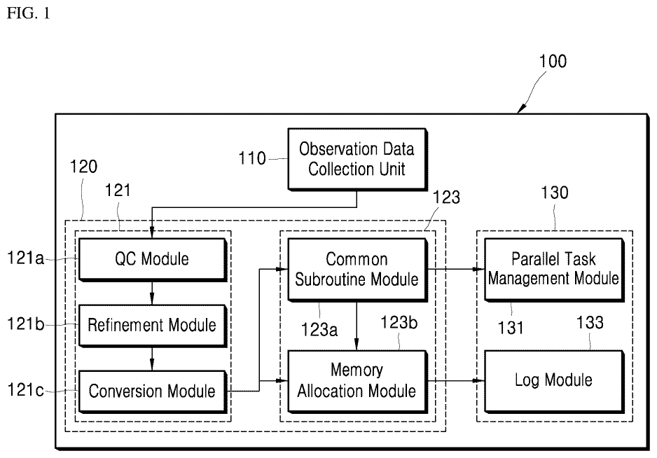

FIG. 1 is a diagram showing a block configuration of an integrated preprocessing system 100 for observation data of an ocean data assimilation system according to an exemplary embodiment of the present disclosure.

The Global Ocean Data Assimilation and Prediction System version 2 (GODAPS2) applied to an exemplary embodiment of the present disclosure refers to a system that collects various ocean observation data in order to more accurately describe the ocean and sea-ice states, and sets initial conditions of ocean and atmospheric prediction models based thereon.

As shown in FIG. 1, an integrated preprocessing system 100 for observation data of an ocean data assimilation system according to an exemplary embodiment of the present disclosure relates to a preprocessing system that collects various observation data required for the ocean data assimilation system, performs quality control (QC) and data refinement processes, and delivers the data to the data assimilation system, and may be configured to include an observation data collection unit 110, a data processing unit 120, and a monitoring unit 130.

Here, the observation data collection unit may be a configuration that collects ocean observation data required for the ocean data assimilation system.

The observation data to be collected by the data collection unit includes various ocean observation data required for the ocean data assimilation system.

This data includes ocean temperature, salinity, sea level, and sea-ice concentration, etc., and may be collected from 16 or more types of various platforms (external platforms or servers), such as buoys, satellites, and Argo floats.

In addition, the data sources of the observation data collected by the data collection unit might be from the KMA-COMIS5 server and numerical model relay servers, and the data providers may be various organizations such as GTS, IFREMER, JPL PODAAC, and COPERNICUS OSI-SAF.

The data formats of the observation data collected by the data collection unit may be various formats such as BUFR, GRIB, and NetCDF.

And, as shown in FIG. 1, the data processing unit 120 is a configuration that performs quality control on the collected observation data and classifies and processes the data into a single executable file, and may be configured to include a quality control unit 121 and a single processing unit 123.

More specifically, the data processing unit 120 may be configured to include a quality control unit 121 that applies QC flags to the collected observation data, refines the collected observation data, and converts the refined observation data into standardized data, and a single processing unit 123 that classifies and processes the converted data into a predetermined single executable file.

Here, the quality control unit 121 may include a QC module 121a that applies QC flags to the collected observation data according to ocean depth, a refinement module 121b that refines the collected observation data verified by the applied QC flags, and a conversion module 121c that converts the refined observation data into a standardized data format in an explicit manner.

The QC module 121a may be a configuration that applies QC flags to each level of the collected observation data in order to evaluate the quality of each piece of data.

That is, the QC module 121a, when values such as depth, water temperature, and salinity do not conform to specific criteria, may consider the corresponding data to be of low quality and exclude it from subsequent processing.

And, the refinement module 121b refines the data verified by the QC flags by removing data with outliers or errors through the refinement process, thereby improving data reliability. For example, in the case of vertical profile data, if outliers are found in depth or pressure, the data of the entire layer may be deleted to prevent distortion.

In addition, the conversion module 121c may be a configuration that converts the collected data into NetCDF, which is a standardized format. In particular, by replacing the existing EMOS library with ECCODES, BUFR and GRIB formatted data can be converted in an explicit manner, and efficient data processing becomes possible through structured programming in Fortran.

In addition, the World Meteorological Organization (WMO) continuously updates and distributes new BUFR tables due to the invention and introduction of the new observation instruments, and by using ECCODES instead of the discontinued EMOS library, the problem of the obsolete tables for observation has been resolved.

And, as shown in FIG. 1, the single processing unit 123 may be configured to include a common subroutine module 123a that classifies and processes the converted observation data into an executable file of a common subroutine, and a memory allocation module 123b that processes the converted observation data using a dynamic memory allocation method based on a linked list.

As such, the common subroutine module 123a of the single processing unit 123 is a configuration of an integrated program that can classify and process all observation data into a single executable file, and through this configuration, users can add new observation data without separate program updates or complicated settings.

In addition, the common subroutine module 123a is a configuration in which all data is processed through the same common subroutine, thereby facilitating code management, and even if new observation data formats are added, it can be handled by updating a single program, thereby reducing maintenance costs.

And, the memory allocation module 123b is a module that performs a memory allocation function based on a linked list. In the past, when processing large-volume observation data, the existing system required more than 100 GB of memory, but by using the dynamic memory allocation method based on a linked list, memory usage can be significantly reduced.

That is, the memory allocation module 123b can reduce the burden in the process of processing large-volume data by efficiently using memory through dynamic memory allocation.

And, as shown in FIG. 1, the monitoring unit 130 may be a configuration that performs GUI-based job scheduling and monitoring using a Rose/Cylc workflow management system.

Here, Rose/Cylc is a system for operating general-purpose numerical models, and this system includes two main components, Rose and Cylc.

Rose is a framework for configuring, managing, and running tasks, and is used to manage the settings and environments required for model execution. Through Rose, users can easily change and adjust various parameters and settings required for model execution.

Cylc is a component responsible for job scheduling and monitoring, and this tool is used to automate and manage complex workflows. Through Cylc, users can set dependencies among multiple tasks, control the execution order, and efficiently monitor the entire process.

The advantages of such a Rose/Cylc workflow management system are: (1) it can be applied to various numerical models; (2) it can automate complex modeling tasks and reduce the user's workload; (3) it can optimize job scheduling and efficiently use computing resources; and (4) it can check and manage the progress of tasks in real time.

As shown in FIG. 1, the monitoring unit 130 may be configured to include a parallel task management module 131 that checks task statuses in real time through a CYLC graph on a GUI basis using a Rose/Cylc workflow management system, and a log module 133 that checks logs of respective tasks on the GUI.

That is, the monitoring unit 130 is a configuration for job scheduling and monitoring, and performs GUI-based job scheduling and monitoring functions by introducing a Rose/Cylc workflow management system.

Through this, the progress of tasks can be grasped at a glance, and errors occurring at each stage can be responded to promptly.

The parallel task management module 131 can check task statuses in real time through a CYLC graph even when multiple tasks are being performed simultaneously, thereby managing dependencies among tasks and improving operational efficiency.

In addition, the log module 133 can easily check the logs of respective tasks on the GUI, thereby quickly identifying and responding to the cause when a problem occurs.

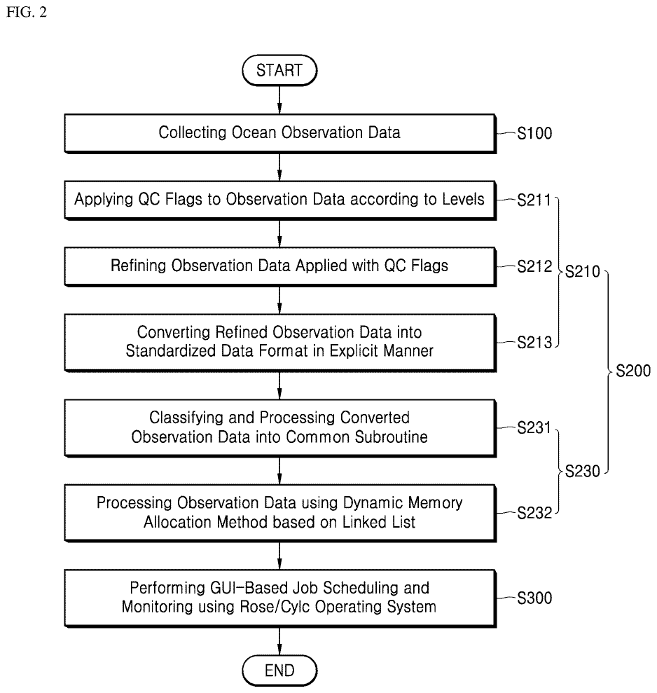

FIG. 2 is a diagram showing a detailed flow of an integrated preprocessing method for observation data of an ocean data assimilation system according to an exemplary embodiment of the present disclosure.

As shown in FIG. 2, an integrated preprocessing method for observation data of an ocean data assimilation system according to an exemplary embodiment of the present disclosure may be configured to include (a) an observation data collecting step S100, (b) a data classifying and processing step S200, and (c) a job scheduling and monitoring step S300.

The step (a) S100 may be an observation data collecting step in which the data collection unit collects ocean observation data required for the ocean data assimilation system.

The step (a) S100 may be a step of collecting various ocean observation data required for the ocean data assimilation system and preparing them for processing in subsequent steps.

In this step, the data include 16 or more types of ocean observation data collected from buoys, satellites, and Argo floats, and the collected data include temperature, salinity, sea level, and sea-ice concentration, and may be provided from various data providers such as GTS, IFREMER, JPL PODAAC, and COPERNICUS OSI-SAF.

The step (b) S200 may be a step in which the data processing unit 120 performs quality control on the collected observation data and classifies and processes the collected observation data using a single executable file.

That is, the step (b) S200 may be a step of classifying and processing the collected observation data through a single executable file and converting it into quality-controlled data.

The step (b) may include the following processes.

1) Application of QC flags: applying quality verification flags (QC flags) to the collected observation data to evaluate the quality of each data, and excluding data of low quality from subsequent processing.

2) Processing through a single executable file: integrating and processing all observation data using a single executable file, thereby managing an integrated program and external control tables without needing to update individual programs whenever new data are added.

3) Utilization of a common subroutine: classifying and processing observation data by using a common subroutine within the single executable file, which may help improve code management efficiency and maintain consistency of data processing.

More specifically, the step (b) S200 may include a step (b1) S210 of applying QC flags to the collected observation data (S211), refining the collected observation data (S212), and converting the refined observation data into standardized data (S213), and a data processing step (b2) S230 of classifying and processing the converted data using a predetermined single executable file S231.

The step (b) S200 may manage the quality of the collected data, convert the data into a standardized format, and improve data reliability.

That is, in this step, QC flags are applied to each data to filter out data of low quality or data with outliers, and such data are refined and converted into standardized data formats. The refined data are converted into standardized formats such as NetCDF to be suitable for assimilating in subsequent steps.

For example, in the past, the existing programs did not use QC flags for vertical profile data of the ocean, and for data of questionable quality, such data could only be filtered in subsequent steps through NEMOQC, so the risk of data contamination remained and required carefulness when using.

In particular, vertical profile data include depth (m) or pressure (Pa), water temperature (° C.), and salinity (PSU), and when suspicious values are included in depth or pressure, misrepresentation of the profile can be intensified.

Accordingly, in the integrated preprocessing method for observation data of an ocean data assimilation system according to an exemplary embodiment of the present disclosure, QC flags can be utilized to delete the entire layer values to increase the reliability of the vertical profile.

More specifically, the step (b1) S210 may include a step of applying QC flags to the collected observation data according to ocean depth (QC levels), a step of refining the collected observation data verified by the applied QC flags, and a step of converting the refined observation data into a standardized data format in an explicit manner.

That is, the step (b1) S210 includes a level-specific QC flag application step S211 and a refining step S212, which may more finely evaluate the quality of data, selectively remove data of low quality, and improve the reliability of the system.

In addition, in the step (b1), QC flags are applied to each level of the collected observation data (such as depth, water temperature, and salinity) to filter out levels where outliers are found.

Through such verification processes, distortion of data in subsequent steps can be prevented, and the refined data are converted into standardized data formats (NetCDF) in an explicit manner.

Meanwhile, in the existing ocean data assimilation system, the EMOS library, which provides an API for standardized data formats, was used, but in the exemplary embodiment of the present disclosure, ECCODES is applied through an upgrade.

BUFR, CREX, and GRIB are table-driven data formats (※ tables are required for encoding/decoding, and when new observation species are added or changes occur, new versions of tables are distributed and used), and periodic updates of tables are required. However, since EMOS has been discontinued, it was difficult to update the tables in use.

In addition, the API of the existing EMOS has a problem that programming for data processing is complicated because it processes data in a non-explicit (implicit) manner (after decoding the message, additional processing is required to obtain specific field values).

Therefore, in the integrated preprocessing method for observation data of an ocean data assimilation system according to an exemplary embodiment of the present disclosure, by adopting the ECCODES library instead of the existing EMOS, the explicitness of data processing has been strengthened, and by adopting explicit data processing, it has become possible to exploit derived type variables of Fortran, thereby enabling structured programming, which is the main trend of modern Fortran.

And, the step (b2) S230 is a data processing step through a single executable file, which may be a step of integrally processing various observation data using a single executable file.

That is, in the step (b2) S230, the data verified by QC flags are delivered to a predetermined single executable file, thereby efficiently classifying and processing the data. Since various data are processed in a consistent manner through a common subroutine in the step S231, the efficiency and simplicity of maintenance can be improved.

Here, the common subroutine-based data classifying and processing step is a step of consistently classifying and processing all observation data through a common subroutine within the single executable file.

Since all observation data are processed through the common subroutine within the single executable file, even when new data formats are added, they can be automatically classified and processed through the subroutine. Through this, code management is facilitated and program maintenance becomes simplified.

The use of separate programs for each observation species leaves room for user confusion, because separate program updates and compilation processes are required when new observation species are acquired and used.

Therefore, in order to secure efficiency in terms of subsequent maintenance and management through a program with a single executable file, in the exemplary embodiment of the present disclosure, confusion of users can be minimized by updating and compiling through a single executable program (common subroutine).

In addition, for the use of a single executable file, the input observation data format is automatically determined and classified by the program and processed, thereby preventing errors caused by user carelessness in advance.

In addition, in the exemplary embodiment of the present disclosure, by utilizing a common subroutine, a new program is developed in consideration of the acquisition and use of new observation data, and a function is added to reflect major characteristics of the observation data through outside-of-program tables, thereby minimizing the necessity of compilation.

And, the data processing step through dynamic memory allocation may be a data processing step using dynamic memory allocation based on a linked list (Step S232).

In this step, when processing large-scale data, memory usage can be optimized to improve the efficiency of the system.

That is, in the conventional system, more than 100 GB of memory was required by allocating fixed memory, but in the present disclosure, by adopting a dynamic memory allocation method based on a linked list, memory usage can be reduced, thereby maximizing memory efficiency when processing large-scale data.

In addition, as shown in FIG. 2, the step (c) S300 may be a step of performing GUI-based job scheduling and monitoring using a Rose/Cylc workflow management system.

More specifically, the step (c) S300 may be configured to include a parallel task management step of checking task statuses in real time through a CYLC graph on a GUI basis from a Rose/Cylc workflow management system, and a step of checking logs of respective tasks on the GUI.

The use of a Rose/Cylc workflow management system in the integrated preprocessing method for observation data of an ocean data assimilation system according to an exemplary embodiment of the present disclosure is because the conventional crontab-based operating system was inefficient in job scheduling and error monitoring.

That is, in the conventional crontab-based operating system, the progress of each task had to be checked one by one by seeing log files, and it was delayed to respond when errors occurred. Therefore, in order to resolve these shortcomings, the integrated preprocessing method for observation data of an ocean data assimilation system according to an exemplary embodiment of the present disclosure introduces the Rose/Cylc workflow management system to reinforce GUI-based job management and monitoring.

As shown in FIG. 2, the step (c) S300, as a parallel task management and real-time monitoring step, can check the status of each task in real time on a GUI basis when multiple tasks are being performed in parallel, and can quickly respond when errors occur.

That is, the integrated preprocessing method according to an exemplary embodiment of the present disclosure can visually check the parallel statuses of multiple tasks through the CYLC graph function of the Rose/Cylc workflow management system and can easily monitor the progress of each task.

In addition, the logs of respective tasks can be checked in real time on the GUI, so that the cause can be identified immediately and responded to when errors occur.

In addition, another exemplary embodiment of the present disclosure may include a computer program stored on a non-transitory medium for executing the integrated preprocessing method of observation data of the ocean data assimilation system according to an exemplary embodiment of the present disclosure.

Further, the program applicable to the integrated preprocessing method of observation data of the ocean data assimilation system according to an exemplary embodiment of the present disclosure may be implemented as computer-readable code on a computer-readable recording medium.

The code and code segments implementing the above programs can be readily deduced by a computer programmer of ordinary skill in the art.

Here, a computer-readable recording medium may include any kind of recording device that stores data that can be read by a computer system.

Examples of computer-readable recording media may include ROM, RAM, CD-ROM, magnetic tape, floppy disk, optical disk, and the like. Further, the computer-readable recording medium may be distributed across a networked computer system and may be written and executed as computer-readable code in a distributed manner.

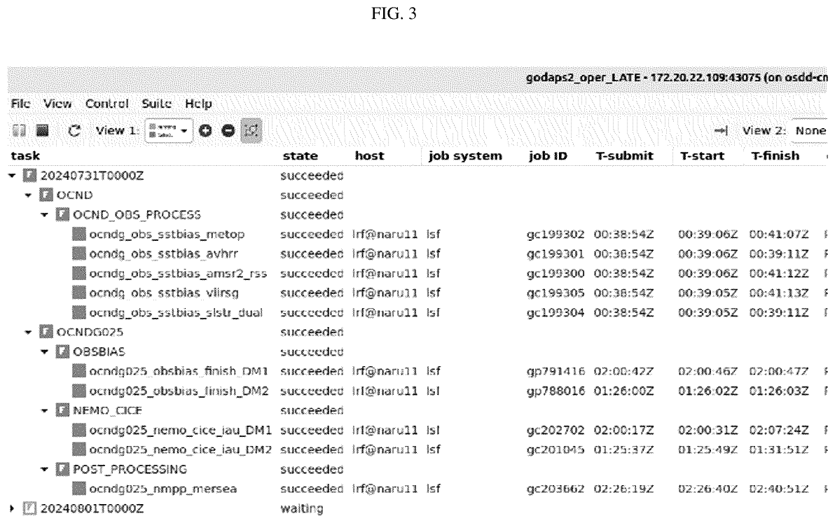

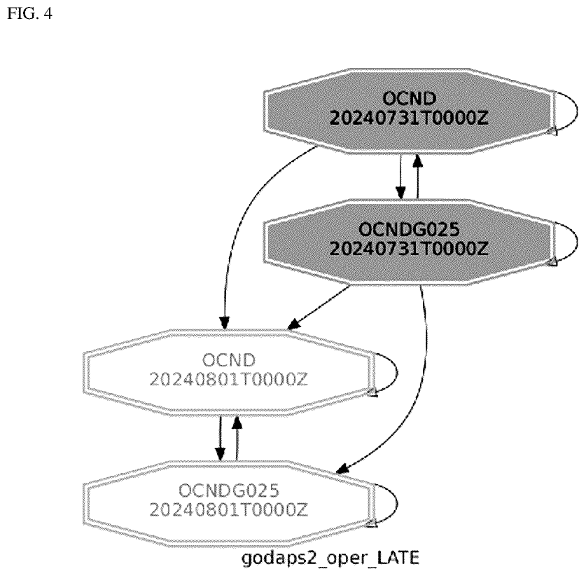

FIG. 3 is a diagram showing a screen of a Cylc window in which tasks are being performed in real time in an ocean data assimilation system according to an exemplary embodiment of the present disclosure. FIG. 4 shows an example of GUI screen displaying task statuses and the like.

With the introduction of the Rose/Cylc workflow management system, convenience in identifying the status of operational services is increased, and it becomes possible to respond quickly in case of failure situations, thereby greatly improving operational stability.

That is, in the exemplary embodiment of the present disclosure, by applying the Rose/Cylc workflow management system as a new operating system, a GUI (Graphical User Interface) is provided so that operational operators can easily check at a glance the processing status of all observation data, and when an error occurs, the error can be quickly identified, thereby minimizing delays in operational services.

As such, the integrated preprocessing method for observation data of an ocean data assimilation system according to the exemplary embodiment of the present disclosure enables efficient collection, quality control, and processing of observation data, and makes stable data assimilation possible by monitoring the preprocessing process through the Rose/Cylc workflow management system.

In addition, it contributes to ensuring the quality of observation data, optimizing memory usage, and enhancing the reliability and operational efficiency of the system through real-time task monitoring.

As such, the integrated preprocessing system 100 and method for observation data of an ocean data assimilation system according to the exemplary embodiment of the present disclosure have the following advantages:

### Integrated Collection and Processing of Various Observation Data

The exemplary embodiment of the present disclosure can explicitly process various formats of data (such as BUFR and GRIB) by utilizing the ECCODES library, and can flexibly respond to the new observation data formats and periodic Table updates.

The exemplary embodiment of the present disclosure can process multiple types of observation data using a single executable file, thereby improving management efficiency. In addition, when a new data format is added, there is no need to update or compile a separate program, and through this, consistency of the preprocessing process can be maintained while also improving data processing speed.

### 2) Improvement of Data Reliability Through Quality Control (QC Flags)

The exemplary embodiment of the present disclosure applies quality control (QC) flags to each level of the collected data, thereby significantly improving data reliability by removing low-quality data in advance.

In particular, in the case of vertical profile data, if outliers are found, the data of the corresponding layer is deleted to ensure that misrepresented data are not included.

In addition, the exemplary embodiment of the present disclosure refines data containing outliers or errors through a quality control process, converts only the verified data into a standardized data format, and prevents data contamination in subsequent stages, thereby improving analysis quality from the data assimilation process.

### 3) Large-Scale Data Processing Through Improvement of Memory Efficiency

The exemplary embodiment of the present disclosure departs from the conventional method of allocating fixed memory for large-scale data processing, and introduces a linked-list-based dynamic memory allocation method to optimize memory usage. Through this, even in cases requiring more than 100 GB of memory, processing can be efficiently performed, thereby improving efficiency in handling large-scale data.

In addition, due to the dynamic memory allocation method, the exemplary embodiment of the present disclosure can save resources and improve system performance, contribute to enhancing overall system stability, and enable smooth data processing under diverse environments.

### 4) Improvement of Management and Monitoring Efficiency Through the Rose/Cylc Workflow Management System

The exemplary embodiment of the present disclosure supports intuitive monitoring of all tasks through the GUI of the Rose/Cylc workflow management system, enables visual confirmation of the parallel progress of multiple tasks through the CYLC graph, and provides high visibility to the operator by allowing easy checking of task logs on the GUI.

In addition, the exemplary embodiment of the present disclosure allows real-time identification of task statuses, thereby enabling immediate identification and response to causes when errors occur, which enhances the stability of system operation, minimizes task delays, and improves overall operational efficiency.

In addition, the exemplary embodiment of the present disclosure allows the Rose/Cylc workflow management system to monitor multiple tasks in parallel, effectively manage the entire process of the preprocessing procedure.

Furthermore, the exemplary embodiment of the present disclosure can clearly manage dependencies between tasks, and improve processing speed through parallel tasks, thereby maximizing efficiency in large-scale data preprocessing.

### 5) Improvement of Integrated Source Code and Maintenance Efficiency

The exemplary embodiment of the present disclosure is designed so that all observation data are processed through a common subroutine, thereby improving code management and maintenance efficiency. Since even newly added observation data formats can be processed through the same subroutine, maintenance costs are reduced and code management is facilitated.

In addition, the exemplary embodiment of the present disclosure manages source code efficiently through FCM (Flexible Code Management), and by systematizing the compilation process, it can maintain consistency of tasks during program updates, improve collaboration and development efficiency, and contribute to reducing confusion that may occur during maintenance tasks.

### 6) Improvement of Overall System Stability and Prediction Accuracy

The exemplary embodiment of the present disclosure, through explicit data processing using QC flags and ECCODES, resource saving through dynamic memory allocation, and error response through real-time monitoring by Rose/Cylc, all contribute to strengthening the stability and prediction accuracy of the ocean data assimilation system. Through this, the initial conditions of the model become more accurate, and the reliability of weather prediction and ocean prediction can be enhanced.

In addition, in the exemplary embodiment of the present disclosure, all tasks are managed in an integrated manner based on a GUI, so that the operator can easily check the progress of tasks. Parallel management between tasks is possible, which not only improves processing speed but also enables immediate response in the event of errors, thereby minimizing delays in the overall preprocessing process.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

100: integrated preprocessing system for observation data
110: observation data collection unit
120: data processing unit
121: quality control unit
121a: QC module
121b: refinement module
121c: conversion module
123: single processing unit
123a: common subroutine module
123b: memory allocation module
130: monitoring unit
131: parallel task management module
133: log module

What is claimed is:

1. An integrated preprocessing system for observation data of an ocean data assimilation system, comprising:
an observation data collection unit configured to collect ocean observation data;
a data processing unit configured to perform quality control on the collected observation data and to classify and process the collected observation data into a single executable file; and
a monitoring unit configured to perform GUI-based job scheduling and monitoring using a Rose/Cylc workflow management system,
wherein the data processing unit comprises:
a quality control unit including a QC module configured to apply QC flags to the collected observation data according to ocean depth, a refinement module configured to refine the collected observation data verified by the applied QC flags, and a conversion module configured to convert the refined observation data into a standardized data format in an explicit manner; and
a single processing unit including a common subroutine module configured to classify and process the converted observation data into an executable file of a common subroutine, and a memory allocation module configured to process the converted observation data using a dynamic memory allocation method based on a linked list.

2. The integrated preprocessing system of claim 1,
wherein the data processing unit comprises:
a quality control unit configured to apply QC flags to the collected observation data, refine the collected observation data, and convert the refined observation data into standardized data; and
a single processing unit configured to classify and process the converted observation data into a predetermined single executable file.

3. The integrated preprocessing system of claim 1,
wherein the monitoring unit comprises:
a parallel task management module configured to check task statuses in real time through a CYLC graph on a GUI basis using a Rose/Cylc workflow management system; and
a log module configured to check logs of respective tasks on the GUI.

4. An integrated preprocessing method for observation data of an ocean data assimilation system, comprising:
(a) an observation data collecting step of collecting ocean observation data;
(b) a data classifying and processing step of performing quality control on the collected observation data, and classifying and processing the collected observation data into a single executable file; and
(c) a monitoring step of performing GUI-based job scheduling and monitoring using a Rose/Cylc workflow management system,
wherein the step (b) comprises:
a step of applying QC flags to the collected observation data according to ocean depth;
a step of refining the collected observation data verified by the applied QC flags;
a step of converting the refined observation data into a standardized data format in an explicit manner;
a step of classifying and processing the converted observation data into an executable file of a common subroutine; and
a step of processing the converted observation data using a dynamic memory allocation method based on a linked list.

5. The integrated preprocessing method of claim 4,
wherein the step (b) comprises:
(b1) a step of applying QC flags to the collected observation data, refining the collected observation data, and converting the refined observation data into standardized data; and
(b2) a data processing step of classifying and processing the converted observation data into a predetermined single executable file.

6. The integrated preprocessing method of claim 4,
wherein the step (c) comprises:
a parallel task management step of checking task statuses in real time through a CYLC graph on a GUI basis using a Rose/Cylc workflow management system; and
a step of checking logs of respective tasks on the GUI.

7. A computer program stored in a medium for executing the integrated preprocessing method for observation data of an ocean data assimilation system according to claim 4 on a computer.
